(19) United States
(12) Patent Application Publication
(10) Pub. No.: US 2026/0361176 A1
(43) Pub. Date: Nov. 12, 2026

(54) MECHANICAL ENERGY STORAGE: TENSEGRITY COMPLIANT MECHANISMS

(71) Applicant: Brigham Young University, Provo, UT (US)

(72) Inventor: Larry HOWELL, Orem, UT (US)

(73) Assignee: Brigham Young University, Provo, UT (US)

(21) Appl. No.: 19/569,957

(22) Filed: Mar. 17, 2026

Related U.S. Application Data
(60) Provisional application No. 63/773,159, filed on Mar. 17, 2025.

(51) Int. Cl. H02K 7/02; B60L 50/30

(52) U.S. Cl. CPC H02K 7/025; B60L 50/30

(57) ABSTRACT

A mechanical energy storage system utilizing a tensegrity compliant mechanism assembly to store elastic strain energy and release it as electrical energy through a generator assembly. The system places compliant members under tension and compression as occurs in tensegrity structures, and may combine multiple units into an array to achieve scalable total energy storage capacity. Stored strain energy is released through an escapement mechanism connected to the generator, analogously to the escapement of a mechanical timepiece. High energy density is achieved by selecting materials with high resilience (Sy\hat{ }2/2E) and by loading all compliant members and structural members in tension or compression so that the full cross section of each member participates in energy storage. Because energy is stored exclusively through elastic deformation and converted through electromagnetic means, the system may provide a theoretically infinite number of charge-and-discharge cycles without material degradation, may be charged rapidly at rates not constrained by chemical kinetics, and operates without electrochemical reactions, hazardous chemical materials, or rare-earth elements.

### BACKGROUND

Tensegrity compliant mechanisms, which integrate the principles of tensegrity (tensional integrity) with compliant design to achieve motion, force transmission, and energy storage through prestressed networks of tensioned and compressed elements, have origins that blend artistic innovation with engineering evolution. The concept of tensegrity itself traces back to early 20th-century explorations, with Karl Ioganson's 1920 sculpture “Gleichgewichtkonstruktion” often cited as a proto-tensegrity system, featuring isolated compression elements suspended in tension, though its direct relevance remains debated. In the 1940s, independent developments emerged: David Georges Emmerich explored self-stressed structures he termed “structures tendues et autotendants” (tensile and self-stressed structures), while Richard Buckminster Fuller and his student Kenneth Snelson advanced the idea in the United States. Snelson created the first recognized tensegrity sculpture in 1949, a floating compression structure with discontinuous struts held by continuous cables. Fuller coined the term “tensegrity” in the 1960s as a portmanteau of “tensional integrity,” applying it to architectural visions like geodesic domes, which rely on prestress for stability.

By the 1960s, tensegrity found practical applications in architecture, such as the Spodek arena in Poland (designed by Maciej Gintowt and Maciej Krasinski), which used a tensegrity-inspired cable system for its roof, and later in structures like David Geiger's Seoul Olympic Gymnastics Arena (1988) and the Georgia Dome (1996). The integration of tensegrity with compliant mechanisms a field emphasizing elastic deformation over rigid joints gained traction in the late 1980s and 1990s. Pioneered by researchers like Ashok Midha at Purdue University, compliant mechanisms drew from historical precedents like the ancient bow and arrow or Leonardo da Vinci's flexible designs, but tensegrity added a layer of prestressed efficiency. Advances in continuum topology optimization and materials science enabled tensegrity compliant systems, offering reduced part counts, frictionless motion, and inherent strain energy storage. In the 21st century, these mechanisms have expanded into robotics, aerospace, micro-electromechanical systems (MEMS), and biomedical devices, with applications in kinematics and cellular biophysics (e.g., Donald Ingber's work on tensegrity in living cells since the 1980s, modeling cytoskeletons as prestressed networks). Today, tensegrity compliant mechanisms are explored for adaptive structures, soft robotics, and energy harvesting, leveraging nonlinear deformation for enhanced performance.

Parallel to the development of tensegrity compliant mechanisms, energy storage technologies have evolved from ancient techniques to advanced systems critical for renewable energy integration. Early civilizations used thermal storage with fire-heated stones in insulated pits or mechanical storage through hydropower reservoirs. The 19th century brought breakthroughs: pumped hydroelectric storage appeared in Italy and Switzerland around the 1890s, while Gaston Plante's 1859 rechargeable lead-acid battery built on Alessandro Volta's 1800 voltaic pile and Benjamin Franklin's 1749 term “battery.” The 20th century diversified options, including flywheels for mechanical storage and molten salt thermal systems in the 1996 Solar Two project.

The late 20th and early 21st centuries saw rapid expansion driven by grid stability needs amid solar and wind growth. Lithium-ion batteries, conceptualized in the 1970s and commercialized in the 1990s, dominate electrochemical storage for their high energy density, though alternatives like sodium-ion batteries provide cost and safety advantages. By the 2010s, global non-pumped hydro storage capacity exploded, with battery energy storage systems (BESS) growing from 0.34 GW in 2017 onward. Modern technologies span mechanical (e.g., compressed air, flywheels), thermal (e.g., phase-change materials), chemical (e.g., hydrogen), and electromagnetic (e.g., supercapacitors) approaches, addressing short- and long-duration requirements.

Despite progress, conventional energy storage faces challenges like material fatigue, efficiency losses, high costs, and scalability issues. Tensegrity compliant mechanisms, with their prestressed elastic networks enabling efficient strain energy storage and release, offer an underexplored avenue for integration into energy storage. Recent studies have applied tensegrity designs in vibration harvesting, multi-stable systems, and electromechanical transduction, enhancing bandwidth and output through prestress-tuned deformation. For example, compliant tensegrity structures paired with piezoelectric or electromagnetic transducers show promise in micro-scale wearables and larger systems optimized for high-capacity storage with minimal components.

However, prior art has not fully exploited tensegrity compliant mechanisms for large-scale, durable energy storage, where prestressed deformation could reduce wear, simplify designs, and accelerate response times. A need persists for innovative systems harnessing these mechanisms to deliver efficient, high-capacity energy storage, mitigating renewable intermittency and advancing sustainable power solutions.

### SUMMARY OF THE DISCLOSURE

Disclosed herein is a mechanical energy storage system that uses compliant mechanisms arranged in a tensegrity-inspired configuration to store strain energy and release it as electrical energy. The system places compliant members in tension and compression, as in tensegrity structures, and combines multiple units into an array to achieve scalable total energy storage capacity. Stored strain energy is released through an escapement mechanism connected to a generator, producing useful electricity. The system achieves high energy density by using materials with high resilience (Sy\hat{ }2/2E) and by loading all elements, including the support structure, so that the full cross section of each member participates in energy storage (for example, by loading in tension or compression rather than bending). The system operates without electrochemical reactions or hazardous chemicals, supports rapid charging not constrained by chemical kinetics, and may provide a theoretically infinite number of charge-and-recovery cycles through purely elastic deformation.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. The advantages of the disclosure will become better understood with regard to the following description and accompanying drawings where:

FIG. 1 illustrates a perspective view of a tensegrity compliant mechanism energy storage unit in an uncharged, undeflected state showing the arrangement of compliant members in tension and compression within the support structure.

FIG. 2 illustrates a perspective view of the tensegrity compliant mechanism energy storage unit of FIG. 1 in a charged, deflected state with stored strain energy.

FIG. 3 illustrates a schematic diagram of a tensegrity compliant mechanism energy storage system showing the escapement assembly and generator assembly connected to release stored strain energy as electrical output.

FIG. 4 illustrates a cross-sectional view of a compliant member under tension loading, showing the uniform tensile stress state and full cross-sectional participation in strain energy storage.

FIG. 5 illustrates a cross-sectional view of a compliant member under compression loading showing the uniform compressive stress state and full cross-sectional participation in strain energy storage.

FIG. 6 illustrates a perspective view of an array of tensegrity compliant mechanism energy storage units arranged for scalable grid-level energy storage deployment.

FIG. 7 illustrates a graph of volumetric energy storage density as a function of material resilience Sy\hat{ }2/(2E) for a range of candidate compliant member materials

### DETAILED DESCRIPTION

In the following description of the disclosure, reference is made to the accompanying drawings, which form a part hereof, and in which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

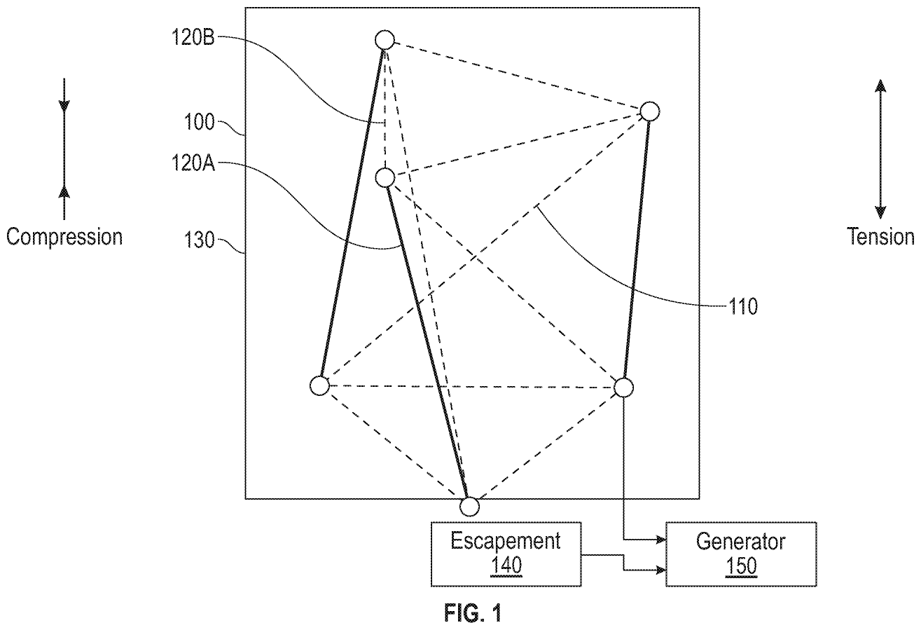

FIG. 1 illustrates a perspective view of tensegrity compliant mechanism energy storage unit 100 in an uncharged, undeflected state. Unit 100 may include a tensegrity compliant mechanism assembly 110 comprising one or more compliant members 120 arranged in a prestressed tensegrity network; a support structure 130 configured to maintain the prestressed configuration and to load compliant members 120 in both tension and compression; an escapement assembly 140 mechanically coupled to tensegrity compliant mechanism assembly 110 and configured to regulate the rate of strain energy release; and a generator assembly 150 mechanically coupled to escapement assembly 140 and configured to convert mechanical energy from the tensegrity compliant mechanism assembly 110 into electrical energy deliverable to a load.

Tensegrity compliant mechanism assembly 110 may store strain energy through elastic deformation of compliant members 120. In the tensegrity arrangement, some compliant members 120 are placed in tension and others are placed in compression, analogously to the tension cables and compression struts of a classical tensegrity structure. This arrangement may allow all cross-sectional area of each compliant member 120 to participate in strain energy storage, maximizing the energy density of unit 100. The energy density (strain energy per unit volume) of each compliant member 120 may be expressed as Sy\hat{ }2/(2E), where Sy is the yield strength and E is the Young's modulus of the member material. This quantity is referred to herein as the material resilience. Compliant members 120 should be fabricated from materials with high resilience to maximize the energy storage capacity of unit 100.

Compliant members 120 may be fabricated from one or more of: spring steels, titanium alloys, carbon fiber composites, carbon nanotube yarns, polymer composites, shape-memory alloys, or other elastic materials selected to maximize resilience while maintaining purely elastic deformation throughout all operating cycles. Because compliant members 120 store energy exclusively through elastic deformation without plastic deformation, chemical reactions, or phase changes, unit 100 may be capable of a theoretically infinite number of charge-and-discharge cycles without material degradation, subject to the applied stresses remaining within the elastic range of the chosen material.

Support structure 130 may maintain the prestressed tensegrity network of compliant mechanism assembly 110 in both the uncharged and charged states. Support structure 130 may include rigid elements, pretensioned cables, or additional compliant members configured to define the overall geometry of the tensegrity network and to distribute applied charging loads across all compliant members 120. In the preferred embodiment, support structure 130 is also designed such that all structural elements, including support members themselves, participate in strain energy storage by being loaded in tension or compression rather than bending, further maximizing the total energy density of unit 100.

The total strain energy U stored in unit 100 may be expressed as: U=sum[(Sy_i\hat{ }2)/(2E_i)*V_i], where the summation is taken over all compliant members and structural members that participate in energy storage, Sy_i is the yield strength of member i, E_i is the Young's modulus of member i, and V_i is the volume of member i. This expression shows that total storage capacity scales linearly with the total volume of participating elastic material and with material resilience. To increase energy storage capacity, unit 100 may be combined in an array with other units, wherein each unit contributes independently to the total stored energy.

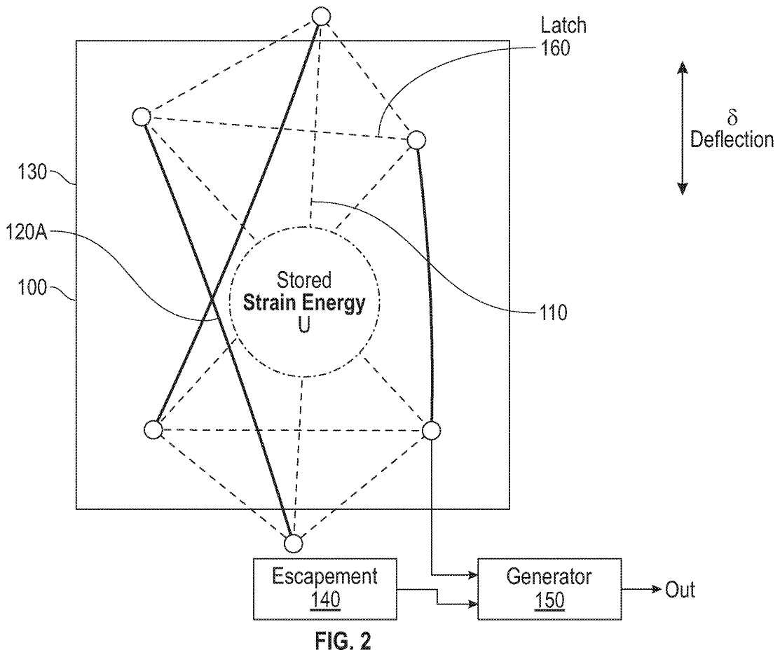

FIG. 2 illustrates a perspective view of unit 100 in a charged, deflected state in which compliant members 120 have been deformed from their natural equilibrium positions and store elastic strain energy. Unit 100 may be charged by applying an external force or torque for example, through a motor operating in motor mode that deforms compliant members 120 from their undeflected equilibrium positions. A latch or locking mechanism (not shown) may hold unit 100 in the charged state until energy release is desired. Charging may be done rapidly because the process is not constrained by chemical kinetics, as in electrochemical batteries, but only by the mechanical bandwidth of unit 100. Furthermore, unit 100 may be recharged by a support vehicle or external power source quickly if accidentally depleted.

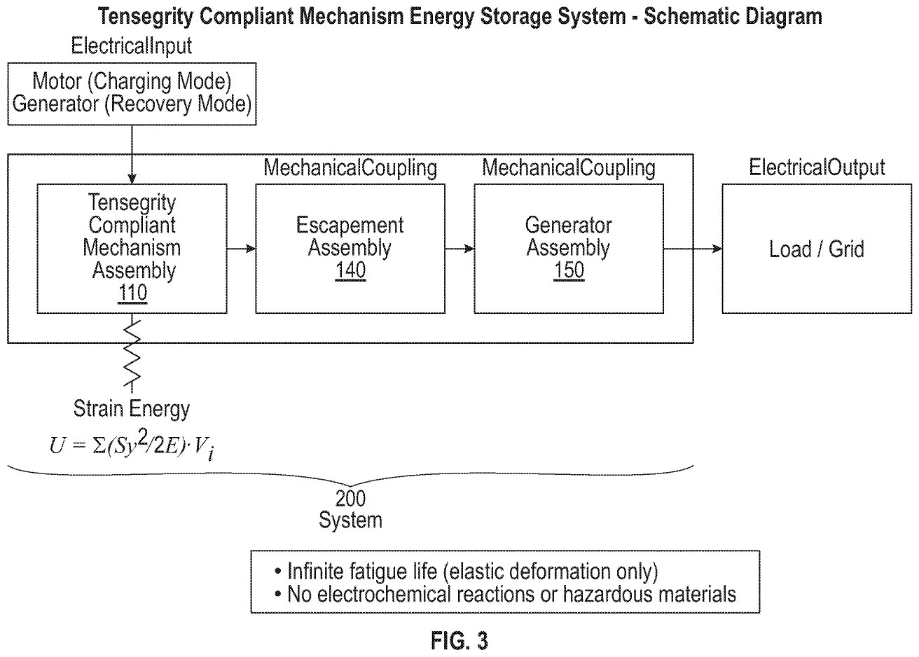

FIG. 3 illustrates a schematic diagram of tensegrity compliant mechanism energy storage system 200 showing escapement assembly 140 and generator assembly 150 connected in series to tensegrity compliant mechanism assembly 110. Escapement assembly 140 may regulate the rate at which stored strain energy is released from compliant mechanism assembly 110 to generator assembly 150. Escapement assembly 140 may operate analogously to the escapement of a mechanical timepiece, wherein a torsion spring stores energy by winding and releases it in a controlled, metered manner through an escape wheel and pallet mechanism. Escapement assembly 140 may include one or more of: a pallet fork, an escape wheel, a detent, or other escapement configurations known in the art. Generator assembly 150 may convert the regulated mechanical output of escapement assembly 140 into electrical energy deliverable to a load or to the power grid.

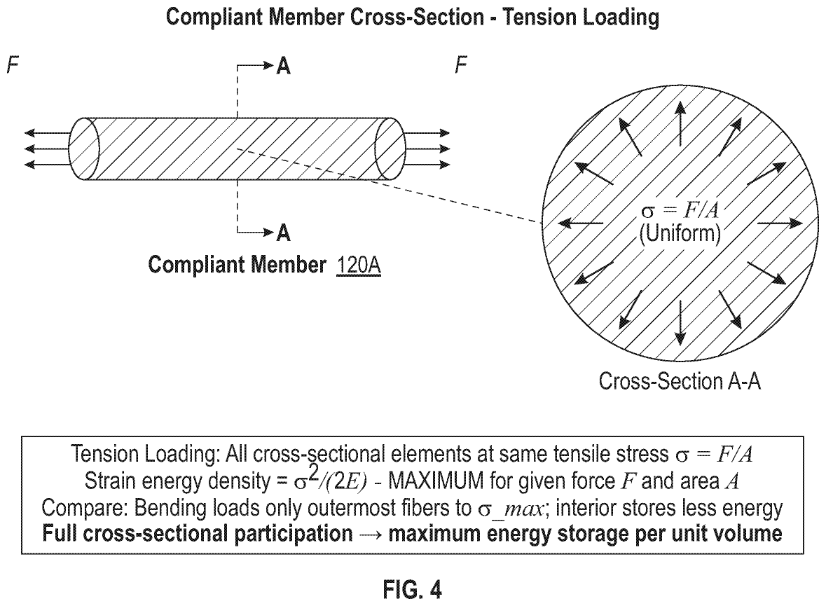

FIG. 4 illustrates a cross-sectional view of compliant member 120A under tension loading. When placed in tension, the full cross-sectional area of compliant member 120A is in a uniform tensile stress state, with every element of the cross section storing strain energy at the same volumetric density. This full cross-sectional participation is a significant advantage of loading members in pure tension compared to bending, where only the outermost fibers reach the maximum allowable stress. The tensile stress at any cross-sectional location during tension loading is sigma=F/A, where F is the applied tensile force and A is the cross-sectional area, and the stored strain energy per unit volume is sigma\hat{ }2/(2E)=F\hat{ }2/(2AE).

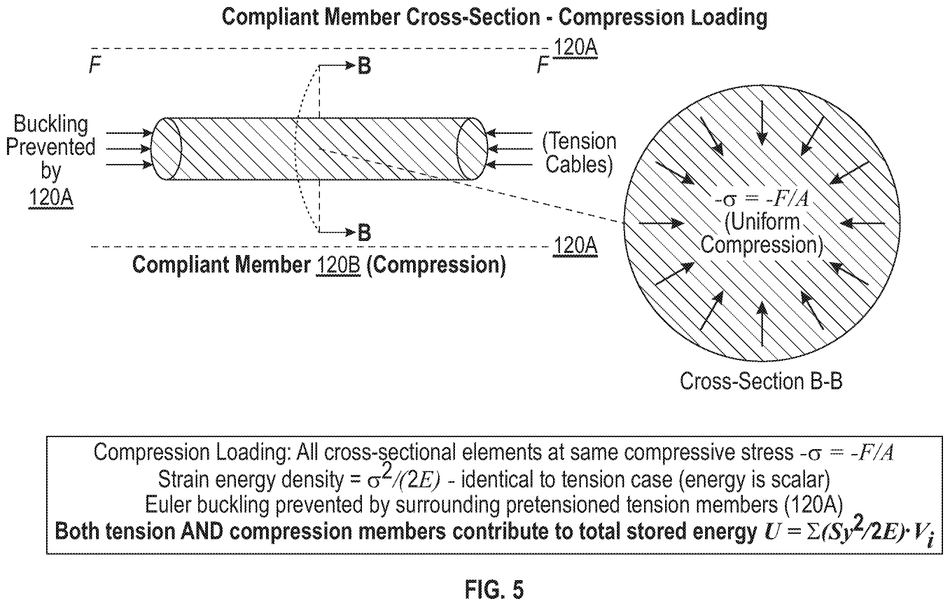

FIG. 5 illustrates a cross-sectional view of compliant member 120B under compression loading. When placed in compression, the full cross-sectional area of compliant member 120B is in a uniform compressive stress state, again achieving full cross-sectional participation in strain energy storage. In the tensegrity arrangement of unit 100, compression members 120B are stabilized against Euler column buckling by the surrounding pretensioned tension members 120A, enabling compression members 120B to store energy efficiently at stress levels approaching the compressive yield strength of the member material without lateral instability. Material selection for compression members 120B should consider slenderness ratio and the associated buckling resistance in the tensegrity network geometry.

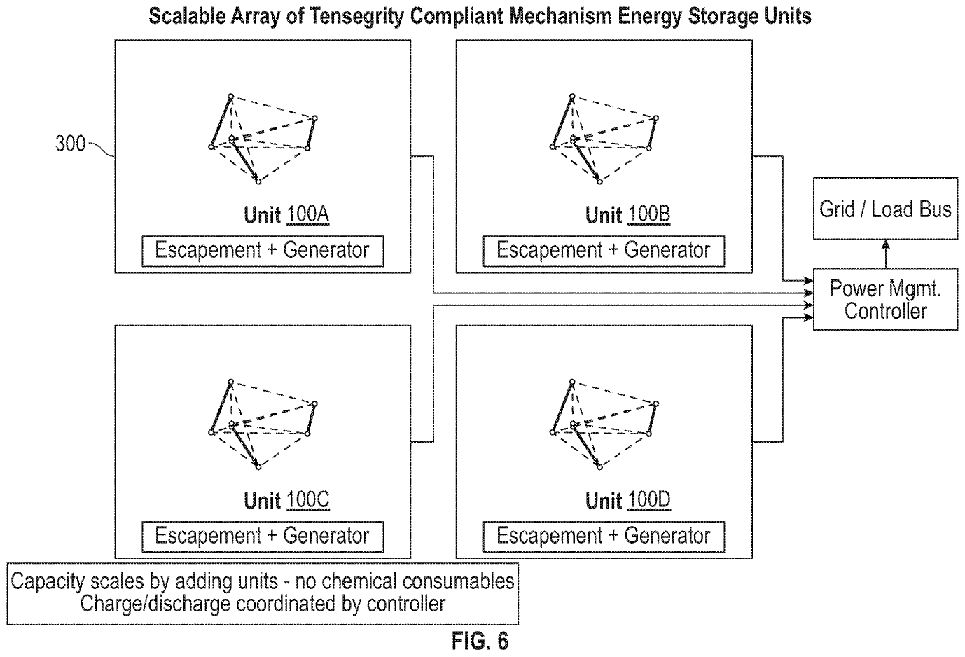

FIG. 6 illustrates a perspective view of array 300 comprising individual tensegrity compliant mechanism energy storage units 100A, 100B, 100C, and 100D configured for scalable grid-level deployment. Array 300 may be charged and discharged under the control of a power management controller (not shown) that coordinates the charging and discharging of individual units to match power supply and demand profiles. The total energy storage capacity of array 300 scales linearly with the number of units. Because each unit 100A-100D stores energy mechanically rather than electrochemically, array 300 may be sized for grid-scale storage using abundant, non-toxic materials without the mining or chemical processing requirements associated with electrochemical battery technologies.

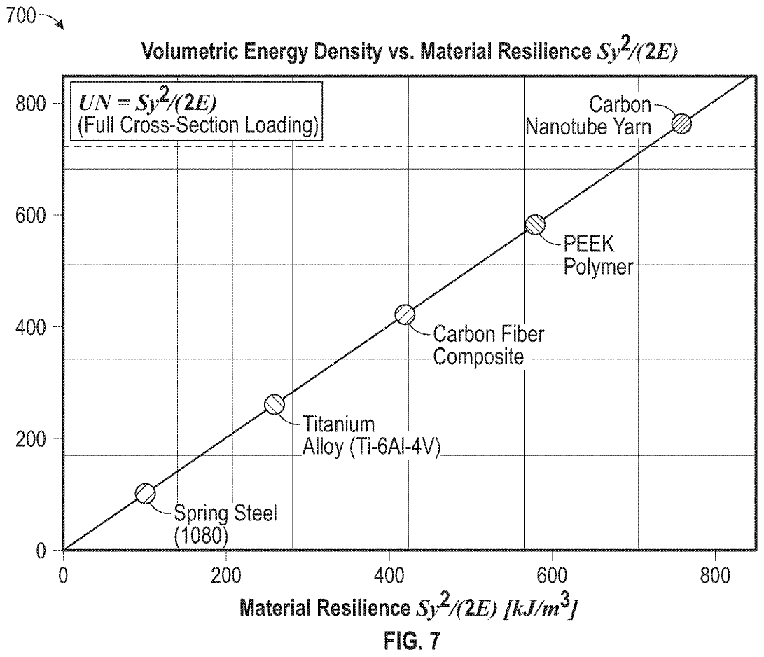

FIG. 7 illustrates a graph of volumetric energy storage density (J/m\hat{ }3) as a function of material resilience Sy\hat{ }2/(2E) for a range of candidate compliant member materials, including spring steel, titanium alloy, carbon fiber composite, carbon nanotube yarn, and selected polymer composites. The graph shows that energy storage density scales linearly with material resilience, confirming that material selection is the primary lever for maximizing the energy density of unit 100. Carbon nanotube yarns and certain titanium alloys offer resilience values significantly higher than conventional spring steel, suggesting that high-performance compliant member materials may enable energy densities in the range competitive with or complementary to electrochemical battery technologies for selected applications.

Unit 100 and system 200 may have application in the following non-limiting situations. In renewable energy applications, renewable energy sources such as solar and wind generate power at times that do not necessarily coincide with times of high demand. Unit 100 may store excess electrical energy generated during high-generation periods and release it as electrical output during high-demand periods, addressing the intermittency challenge of renewable sources without using chemical batteries. In transportation applications, current electric vehicles have limitations in range and charging time compared to internal combustion engine vehicles. Unit 100 may be charged quickly on a timescale comparable to refueling a gasoline vehicle, because charging is a mechanical rather than a chemical process, and unit 100 may be recharged by a support vehicle if accidentally depleted. In consumer electronics applications, unit 100 may provide mechanical energy storage competitive with chemical batteries in appropriate size ranges, or may enable nearly instantaneous recharge in applications where rapid recharge is more valuable than absolute energy density.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A mechanical energy storage system, comprising:
a tensegrity compliant mechanism assembly comprising one or more compliant members arranged in a prestressed tensegrity network, the tensegrity compliant mechanism assembly configured to store strain energy through elastic deformation of the one or more compliant members such that at least some of the one or more compliant members are loaded in tension and at least some of the one or more compliant members are loaded in compression;
a support structure configured to maintain the prestressed tensegrity network and to distribute applied loading across the one or more compliant members; and
a generator assembly mechanically coupled to the tensegrity compliant mechanism assembly and configured to convert strain energy released from the tensegrity compliant mechanism assembly into electrical energy.

2. The system of claim 1, further comprising:
an escapement assembly interposed between the tensegrity compliant mechanism assembly and the generator assembly, the escapement assembly configured to regulate a rate of strain energy release from the tensegrity compliant mechanism assembly to the generator assembly.

3. The system of claim 1, wherein the one or more compliant members are loaded such that substantially the full cross-sectional area of each compliant member participates in strain energy storage through a substantially uniform stress state across the cross section.

4. The system of claim 1, wherein a total strain energy U stored in the system is expressed as:
$$U = sum [ ( Sy\_i \hat{} 2 / 2 E\_i ) * V\_i ] ,$$
where the summation is taken over all compliant members participating in energy storage, Sy_i is the yield strength of member i, E_i is the Young's modulus of member i, and V_i is the volume of member i.

5. The system of claim 4, wherein the one or more compliant members are fabricated from a material selected to maximize the material resilience Sy\hat{ }2/(2E), the material resilience being the primary determinant of volumetric energy storage density of the system.

6. The system of claim 1, wherein the one or more compliant members are fabricated from one or more of: spring steel, titanium alloy, carbon fiber composite, carbon nanotube yarn, polymer composite, shape-memory alloy, or other elastic material selected to maximize energy storage density while maintaining elastic deformation throughout all operating cycles.

7. The system of claim 1, wherein the one or more compliant members are designed to operate exclusively within the elastic range of the member material such that no plastic deformation occurs during any charge or discharge cycle, providing a theoretically infinite number of charge-and-discharge cycles without material failure.

8. The system of claim 1, wherein the system stores and releases energy exclusively through mechanical strain energy and electromagnetic energy conversion, without electrochemical reactions or hazardous chemical materials, such that the system is manufacturable and disposable without chemical waste treatment.

9. The system of claim 1, wherein the tensegrity compliant mechanism assembly is chargeable at a rate limited only by the mechanical bandwidth of the system and not constrained by chemical kinetics, enabling charge times substantially shorter than electrochemical battery systems of comparable energy storage capacity.

10. The system of claim 1, further comprising a plurality of tensegrity compliant mechanism energy storage units each comprising a respective tensegrity compliant mechanism assembly and support structure, the plurality of units arranged in an array and connected to a common power bus or controller configured to charge and discharge individual units in a coordinated manner.

11. The system of claim 1, wherein compression members of the tensegrity compliant mechanism assembly are stabilized against lateral buckling by pretensioned tension members of the tensegrity network, enabling the compression members to store compressive strain energy at stress levels approaching the compressive yield strength of the compression member material.

12. The system of claim 1, wherein the system is configured to be charged during periods of excess electrical generation by a renewable energy source and to release stored strain energy through the generator assembly as electrical output during periods when the renewable energy source does not generate sufficient power to meet demand.

13. The system of claim 1, wherein the support structure comprises one or more structural members also configured to store strain energy through elastic deformation, all structural members and compliant members being loaded in tension or compression rather than bending such that full cross-sectional participation in energy storage is maintained throughout the system.

14. A mechanical energy storage system, comprising:
a compliant mechanism assembly comprising one or more compliant members configured to store elastic strain energy through deformation, the one or more compliant members being loaded in at least one of tension or compression such that substantially the full cross-sectional area of each compliant member participates in energy storage;
an escapement assembly mechanically coupled to the compliant mechanism assembly and configured to release stored strain energy at a controlled rate, the escapement assembly operating analogously to the escapement mechanism of a mechanical timepiece; and
a generator assembly mechanically coupled to the escapement assembly and configured to convert strain energy released through the escapement assembly into electrical energy.

15. The system of claim 14, wherein the escapement assembly comprises at least one of a pallet fork, an escape wheel, or a detent configured to meter the release of stored strain energy from the compliant mechanism assembly to the generator assembly.

16. The system of claim 1, wherein the system is incorporated into an electric vehicle to provide mechanical energy storage for vehicle propulsion, the system being chargeable in a time comparable to refueling an internal combustion engine vehicle with liquid fuel.

17. The system of claim 1, wherein one or more components of the system are manufactured by one or more of: computerized numerical control machining, wire electrical discharge machining, waterjet cutting, laser cutting, stereolithography, selective laser sintering, fused deposition modeling, multi-jet fusion, direct metal laser sintering, electron beam melting, or polyjet three-dimensional printing.

18. The system of claim 1, wherein the system is sized for use in a consumer electronics device and provides mechanical energy storage with rapid recharge capability.

19. A scalable mechanical energy storage array, comprising:
two or more tensegrity compliant mechanism energy storage units, each unit comprising:
a tensegrity compliant mechanism assembly comprising one or more compliant members arranged in a prestressed tensegrity network configured to store strain energy through elastic deformation; a support structure maintaining the prestressed tensegrity network;
and a generator assembly mechanically coupled to the tensegrity compliant mechanism assembly; and
a power management controller connected to each of the two or more units and configured to coordinate charging and discharging of individual units to match a power supply profile to a power demand profile.

20. The array of claim 19, wherein each unit stores and releases energy exclusively through mechanical strain energy and electromagnetic energy conversion without electrochemical reactions, hazardous chemical materials, or rare-earth materials, such that the array is scalable to grid-level energy storage capacity using abundant, non-toxic materials.
